(19) United States
(12) Patent Application Publication
(10) Pub. No.: US 2009/0132930 A1
(43) Pub. Date: May 21, 2009

(54) E-MAIL COMMUNITY SYSTEM FOR A NETWORK GAME AND PROGRAM THEREFOR

(76) Inventors: Ai Erikawa, Pasadena, CA (US); Shozo Ueno, Kanagawa-ken (JP); Katsutoshi Kawada, Kanagawa-ken (JP)

Correspondence Address: MARSH, FISCHMANN & BREYFOGLE LLP, 8055 East Tufts Avenue, Suite 450, Denver, CO, 80237, US

(21) Appl. No.: 11/572,390

(22) PCT Filed: Jul. 21, 2004
(86) PCT No.: PCT/JP2004/010328

§ 371 Date: Jul. 25, 2007

(51) Int. Cl. G06F 3/048; G06F 15/16

(52) U.S. Cl. 715/752; 709/206; 715/757

(57) ABSTRACT

[Problems to be Solved] The object of the present invention is to permit usage of a character name in a network game for safe free communication with each other in cooperation of the e-mail between inside and outside the game without disclosure of the outside-mail address, which is privacy information. To this end, the present invention is characterized by a step of associating a character name with an Internet e-mail address and recording them in the dedicated server, and a step wherein when the terminal equipment of a mail source is connected to the game, an inside-game mail from the mail source using a character name is received and a character name of a destination is acquired, thereafter if the destination is not playing the game at present and the Internet e-mail address has been registered, then an arrival message is transmitted as the Internet e-mail addressed to the Internet e-mail address and thereafter the inside-game mail is converted to a WEB mail format to perform an external e-mail transmission by a WEB mail addressed to the game character name as required by the destination.

### FIELD OF THE INVENTION

This invention relates to e-mail community system, program, and recording medium, and more particularly to an e-mail community system, program, and recording medium to permit the player operating terminal equipment to transmit/receive communications in a manner according to the circumstances irrespective of whether the player is playing a network game or not and to use a character name in the network game which avoids notification of the Internet e-mail address each other for maintaining privacy.

### BACKGROUND ART

Recently, there arose remarkable progress in communication technology and increasing number of Internet user owing to the widespread proliferation of broadband. With this progress, a network game has become popular, which many players can join the game at the same time through the network.

The network game includes a lobby server type and a multiple-participant type. The multiple-participant type includes MMORPG (Massively Multiplayer On-line Role Playing Game) type which allows many players to join.

In the lobby server type, a number of game players are divided into group of e.g. eight players, and a terminal equipment of one game player in each group is set as a host machine, and the terminal equipment of the rest of the game players of each group are set as client machines to share a single virtual space by one group. A dedicated server of the center meditates transmitting and receiving of game commands of the terminal equipment in each group, while actual game program is executed on each terminal equipment.

On the other hand, in the multi-participant MMORPG type, a dedicated server of the center as a host machine executes actual main game programs, intensively administrates the virtual space the terminal equipment share, and proceeds the game by transmitting and receiving the game commands among the terminal equipment.

Further, in the network game of the MMORPG type, a number of players, such as thousands player, can connect to the high-specification dedicated server administrated by game provider to join the game, which has become popular in recent years.

Also in the network game of MMORPG type, the game proceeds while the players on the terminal equipment are operating characters representing themselves in the virtual space. One of the characteristic features of the MMORPG network game is an e-mail feature as communication means between the characters.

Such e-mail feature is disclosed in document 1 mentioned later.

The document 1 discloses as follows. Firstly, the processes are carried out as follows:

(1) A terminal 1 (e.g. PDA, Personal Digital Assistant) transmits, to a server (lobby service server), a first e-mail for demanding a selection of game opponents to play with;
(2) The server stores a game ID contained in the received first e-mail as well as an e-mail address of the terminal 1 with those correlation;
(3) The server searches, from the stored data, an e-mail address of a terminal 2, other than that of terminal 1 having the identical game ID, as the opponent for the game;
(4) After the server found the e-mail address of the terminal 2, the terminal 1 transmits a second e-mail to the server for an execution of the game;
(5) The server converts the e-mail address of the terminal 1 contained as a sender in the received second e-mail into a different e-mail address (such as e-mail address of the server); and
(6) The server transmits the second e-mail to the terminal 2.

The address of the mail source is always converted (see paragraphs [0452], [0472], and [0498]). The address of the destination (receiver) is converted into e.g. the e-mail address of the server as indicated in paragraph [0481].

The e-mail address of the terminal 1, sender, is converted into “aaa.ne.jp”, while the e-mail destination address of the terminal 2, receiver, is converted into “server.co.jp”.

Also in the reference 1, when the player of the terminal 1 enters the address of the server displayed on the screen (“server.co.jp”) in a destination field of and transmits the e-mail, the server automatically converts the destination address and the e-mail is transmitted to the terminal 2 even if the player of the terminal 1 does not know the e-mail address of the opponent terminal 2 (“bbb.ne.jp”). It is noted that the server is notified of the address of the receiver (“bbb.ne.jp”) by the first e-mail.

Further, according to the reference 1, while the sender's address (“aaa.ne.jp”) is transmitted as the mail source to the destination address, this address is converted by the server (into “server.co.jp”). On this account, it is the same as the present invention in that the receiver is not notified of the sender's address (“aaa.ne.jp”).

Reference 1 assumes the game utilizing a standard e-mail (see paragraphs [0002]-[0005]), instead of the network game through ordinal WWW (World Wide Web) as in the present invention. All data regarding the game are transacted through the e-mail between the terminal and the game server.

Although the address “server.co.jp” is still an address used in the game, the reference 1 does not obviously separate the e-mail community system into inside-game and outside-game as in the present invention, rather treating the outside-game only.

The converted address of the reference 1 is illustrated only as “server.co.jp”, and it is not the address allocated as a character name as in the present invention.

In the reference 1, the address of the destination is only mentioned in paragraph

It is understood that in transmitting, when a particular address (“server.co.jp”) is entered as the receiver's address and the e-mail is transmitted, the address should be automatically converted into the opponent's address (“bbb.ne.jp”) found in advance by the server and the e-mail should be sent to the destination. The reference 1 does not recite in this regard.

Just for reference, with regard to other communication features, terminal equipment (such as a personal computer, mobile phone, and PDA) operated by the player is connected to the Internet through dial-up line, Internet service provider (ISP), and the like.

If the e-mail received through the Internet has a domain address addressed to this mail server, the mail server stores the received e-mail in its mail box, or transfers to the other mail server if it does not have such domain address.

A program for displaying the text of the mail for editing, and transmitting/receiving the e-mail is called a mailer. Representative mailer is Outlook Express™ of Microsoft in U.S.

The mail server transmits and receives the e-mail with the mailer. Representative mail server program is Sendmail™ of Sendmail.

It is an SMTP (Simple Mail Transfer Protocol) that is a communication protocol widely used for the mailer to transmit the e-mail to the mail server and for transferring the e-mail between the mail servers. Also it is a POP3 (Post Office Protocol Version 3) that is widely used as a communication protocol for the mailer to receive the e-mail from the mail server.

Ports allocated for SMTP and POP3 are different, so that the mailer communicates with the mail server through the port allocated for SMTP in transmitting the e-mail and through the port allocated for POP3 in receiving the e-mail.

In a header of the transmitted e-mail, updated information is added thereto each time the mailer is transmitted through the mail server.

As in the ordinal letter, “From” filed in the header stores the sender's e-mail address, “To” filed the receiver's e-mail address, and “Subject” field a subject of the e-mail.

The mailer inserts the e-mail address of the sender into the “from” filed in the header. This e-mail address is also utilized as the address for reply.

There are some mailers that change the address for reply when “Reply-to” filed is set for the e-mail address for reply.

In order to transmit the e-mail, the mailer should be provided with proper setting of the e-mail address corresponding to the mailer and of a host name of the mail server compliant with the SMTP.

Based on the host name of the mail server compliant with the SMTP, the mailer transmits the e-mail to the mail server.

Domain name is described or indicated by name and property of organization and country code with an addition of a dot (e.g. “koei.co.jp”), and the e-mail address and the host name are described based on this domain name.

More particularly, the e-mail address is indicated by adding “@” mark as a separation letter to a user name, and the domain name is added thereto (e.g. “user@koei.co.jp”).

The host name is indicated by adding the dot as the separation letter to the server name, and the domain name is added thereto (e.g. “mailserver.koei.co.jp”).

In transmission of the e-mail, the mailer needs to obtain an IP (Internet Protocol) address that is allocated to the host.

The IP address is described by combination of numerals and dots, such as “192.168.0.3”.

Also a system to convert the host name into the IP address is a DNS (Domain Name System).

In the Internet, many DNS servers are provided and if the host name is transmitted to any DNS server, it replies the IP address that is allocated to the host name.

Before accessing to the mail server, the mailer receives the IP address of the mail server supplied from the DNS server.

Then following the protocol of the SMTP, the mailer transmits the e-mail to the mail server at the IP address.

More particularly, a format of the e-mail used inside the network game is a standard data format (header section plus body section) defined by a RFC (Request For Comment) 822, and required headers are added (data link layer addition header, IP header, and TCP header) to provide a certain packet format compliant with the TCP (Transmission Control Protocol)/IP (Internet Protocol).

When transmitting, the SMTP number is stored for a port number of the receiver in the TCP header.

The reference 1 describes conversion of the addresses in the “From” and “To” fields, but the mail data formats etc. are not converted. This is merely a transmission of the standard e-mail outside the game.

[Patent document 1] JP Laid-Open No. 2002-297509

### DISCLOSURE OF THE INVENTION

### Problems to be Solved by the Invention

In the conventional MMORPG network game, the e-mail addresses used inside and outside the game are obviously distinguished or separated.

This is because, while the player registered by the dedicated server is given a dedicated e-mail address exclusively used in the game (also referred to as “inside-game address”) and an account ID for identification of the player, only the dedicated e-mail address or the account ID is allowed to use for exchanging the e-mails in the game in order to eliminate the need to use the ordinal Internet addresses, which are personal information of the sender, to avoid careless notification (disclosure) of such Internet address to the opponent. The inside-game mail address herein refers to e.g. a character name, not the Internet e-mail address.

Due to such distinction, the e-mail can only be exchanged between the players who are playing the network game at present.

On the other hand, it is inconvenient that the e-mail cannot be directly exchanged between the player who is playing the network game and the player who is not playing.

More particularly, the network game must be initiated once to read and write the e-mail in the network game. If the player, who is wanted a relatively prompt communication in the network game, is not playing the network game at the moment, the opponent must interrupt or quit the game to start the mailer for transmitting the e-mail using the ordinal Internet e-mail address other than the network game, which is bothering.

In this regard, it is believed that one can enjoy the network game more by a free (unrestricted) exchange of the e-mails between inside and outside of the network game without leaking of the private information. For example, the player can instantly send the e-mail to friendly group to ask for advice to deal with enemy characters in the network game, or to ask for gathering to start the battle in group.

The object of the present invention is to permit usage of a character name in a network game for free communication with each other in cooperation of the e-mail between inside and outside the game without disclosure of the outside-mail address, which is a privacy information, and to prevent problems, before they occur, since harassing, stalking, and troublesome mailing can lead to a large problem to affect the administration of the game in the multiple-participant network game.

Incidentally, the present invention utilizes a WEB mail system dedicated for the outside the game for communication outside the game.

(1) Communication systems of inside-game mail, WEB mail, and Internet e-mail (electrical mail or Internet mail) are known art.

In the inside-game mail where users playing the game transmit/receive the communication between PC terminals through the game server, the PC terminal transmits a user account ID and IP address at the beginning of the game and then a game server, which is a dedicated server, receives this transmission and authenticates for connection, so that the users and the PC terminals are identified and the subsequent transmission/reception of the e-mail is therefore permitted.

On this account, the communication opponents have already been identified without using the individual Internet e-mail addresses in mail source and destination fields of the e-mail. In these fields, any information can therefore be included based on a rule defined for inside-game beforehand, such as a character name the user operation.

In particular, while a single user can operate more than one character in the present invention, the user can separately use further plural character names for transmission/reception of e-mail.

Eventually, not using the Internet e-mail address or private mail address, this system retains a high level of security.

In addition, the inside-game mail is one of features of the network-game, which data are transmitted and received by a known protocol unique to the game as in the data game and commands.

(2) Combination of inside-game mail and WEB mail, and usage of character name in the WEB mail are novel.

In general, a WEB mail is often provided by a major company operating a portal site (major web site for entrance to the Internet) as an original service. Unlike the ordinal standard Internet e-mail, every message is administrated by a server on a web site side. On the other hand, on a terminal side, browsing of received e-mails and preparation and transmission of new massage are allowed by entering a dedicated web page by an ordinal web browser through a HTTP, not by the mailer.

By using the WEB mail system to permit the game server supplied by the game provider, not the ISP mail server, to administrate the transmitted/received e-mail, and by permitting the game server to identify the user and the mobile terminal determining from the user account ID and IP address as in the inside-game mail, the character name can be utilized in the mail source and destination fields. On this account, a private Internet e-mail address including domain name etc. is no longer needed for communication, which enhances levels of security. In this case, combination of inside-game mail and the WEB mail is advantageous in that the mail data can be commonly used except for the transfer protocol etc.

(3) Usage of Internet e-mail only for an arrival message (arrival or receipt e-mail) and usage of WEB mail thereafter are also novel. The arrival message herein described is a feature to display message when the e-mail is arrived.

In communication from inside-game through the game server to the outside-game, only an initial message, the arrival message, is transmitted as the Internet e-mail from the game server to the outside-game, and the subsequent communications are made through the WEB mail between the game serve and the outside-game.

At this moment, the mail source field in the arrival message is automatically described as the e-mail address of the game server. However, this automatic description is not intended for hiding the private Internet e-mail address of the mail source as in a first embodiment of the present invention. It is inherently irrelevant with the hiding of the mail address, since a conventional transmission/reception from the terminal PC1 to the game server is made by using the character name, not the private Internet e-mail address.

Incidentally, it is still possible to allow the arrival message to include the main body of the e-mail and allow all of the subsequent communications to be transmitted/received as the Internet e-mail instead of the WEB mail. If the Internet e-mail is used, it is however disadvantageous in that there may be limit for the number of characters that can be transmitted when the terminal is a mobile phone, and that security system may be needed since the private Internet e-mail address must be utilized instead of the character name. The WEB mail is superior in that hyper links are easily described in the main body of the e-mail, which is a better operability.

On the other hand, the reason why the arrival message is transmitted at first is to notify a destination user of arrival of an unread WEB mail. This eliminates the need for the user to voluntarily check for arrival of the WEB mail. Assuming that the user should always check for the arrival of the WEB mail, the e-mail community system would be achieved by transmission of only the WEB mail, without transmission of the arrival message. However, the system utilizing the arrival message has significance since if the receiver utilizes the mobile phone which may be powered always, the mailer is always operating (standby status) and therefore the system of the arrival message permits the receiver to be instantly notified of the arrival of the message.

(4) When the user sends the e-mail from the outside-game to inside-game, the user initially enters to the dedicated WEB page and designate the character name for sending the WEB mail.

The game server at first receives the user account ID and IP address and authenticates, and thereafter the subsequent transmission/reception of the e-mail is allowed.

### Means to Solve the Problems

In order to obviate above-mentioned inconvenienced, the present invention provides an e-mail community system for a network game, in the multi-participant network game which proceeds by intensively administrating the virtual space shared by a dedicated server and each terminal equipment and by transmission/reception between the dedicated server and the terminal equipment, as the network game proceeds by the players on terminal equipment operating characters of each user displayed in the virtual space, the character of the player on one terminal equipment can communicate with the characters operated by other users on their terminal equipment, including a step wherein when the terminal equipment of a mail source is connected to the game, an inside-game mail using a character name is received and a character name of a destination is acquired, thereafter if the destination is playing the game at present, then an internal e-mail by the inside-game mail is transmitted as required by the destination, whereas if the destination is not playing the game at present, then the inside-game mail is converted into a WEB mail format to perform an external e-mail transmission by a WEB mail addressed to the character name.

Also the present invention provides an e-mail community system for a network game, in the multi-participant network game which proceeds by intensively administrating the virtual space shared by a dedicated server and each terminal equipment and by transmission/reception between the dedicated server and the terminal equipment, as the network game proceeds by the players on terminal equipment operating characters of each user displayed in the virtual space, the character of the player on one terminal equipment can communicate with the characters operated by other users on their terminal equipment, including; a step of associating a character name with an Internet e-mail address of the player on the terminal equipment and recording them in the dedicated server; and a step wherein when the terminal equipment of a mail source is connected to the game, an inside-game mail using a character name is received and a character name of a destination is acquired, thereafter if the destination is playing the game at present, then an internal e-mail by the inside-game mail is transmitted as required by the destination, whereas if the destination is not playing the game at present and the Internet e-mail address has been registered, then an Internet e-mail is used to transmit an arrival message addressed to the Internet e-mail address corresponding to the character name and thereafter the inside-game mail is converted to a WEB mail format to perform an external e-mail transmission by a WEB mail addressed to the game character name as required by the destination.

Further, the present invention provides an e-mail community system for a network game, in the multi-participant network game which proceeds by intensively administrating the virtual space shared by a dedicated server and each terminal equipment and by transmission/reception between the dedicated server and the terminal equipment, as the network game proceeds by the players on terminal equipment operating characters of each user displayed in the virtual space, the character of the player on one terminal equipment can communicate with the characters operated by other users on their terminal equipment, including a step wherein when the terminal equipment of a mail source is connected to a WEB page, a WEB mail using a character name is received and the WEB mail is converted into an inside-game mail format and a character name of a destination is acquired, thereafter if the destination is playing the game at present, then an internal e-mail by the inside-game mail is transmitted as required by destination, whereas if the destination is not playing the game at present, then the inside-game mail is converted to a WEB mail format to perform an external e-mail transmission by a WEB mail addressed to the game character name.

Still further, the present invention provides an e-mail community system for a network game, in the multi-participant network game which proceeds by intensively administrating the virtual space shared by a dedicated server and each terminal equipment and by transmission/reception between the dedicated server and the terminal equipment, as the network game proceeds by the players on terminal equipment operating characters of each user displayed in the virtual space, the character of the player on one terminal equipment can communicate with the characters operated by other users on their terminal equipment, including; a step of associating a character name with an Internet e-mail address of the player on the terminal equipment and recording them in the dedicated server; and a step wherein when the terminal equipment of a mail source is connected to a WEB page, an WEB mail using a character name is received and WEB mail is converted into an inside-game mail format and a character name of a destination is acquired, thereafter if the destination is playing the game at present, then an internal e-mail by the inside-game mail is transmitted as required by the destination, whereas if the destination is not playing the game at present and the Internet e-mail address has been registered, then an Internet e-mail is used to transmit an arrival message addressed to the Internet e-mail address corresponding to the character name and thereafter the inside-game mail is converted to a WEB mail format to perform an external e-mail transmission by a WEB mail addressed to the game character name as required by the destination.

Also, the present invention provides a program of e-mail community system for a network game, in the multi-participant network game which proceeds by intensively administrating the virtual space shared by a dedicated server and each terminal equipment and by transmission/reception between the dedicated server and the terminal equipment, as the network game proceeds by the players on terminal equipment operating characters of each user displayed in the virtual space, the character of the player on one terminal equipment can communicate with the characters operated by other users on their terminal equipment, the program functioning as means wherein when the terminal equipment of a mail source is connected to the game, an inside-game mail using a character name is received and a character name of a destination is acquired, thereafter if the destination is playing the game at present, then an internal e-mail by the inside-game mail is transmitted as required by the destination, whereas if the destination is not playing the game at present, then inside-game mail is converted into a WEB mail to perform an external e-mail transmission by a WEB mail addressed to the game character name.

Further the present invention provides a program of e-mail community system for a network game, in the multi-participant network game which proceeds by intensively administrating the virtual space shared by a dedicated server and each terminal equipment and by transmission/reception between the dedicated server and the terminal equipment, as the network game proceeds by the players on terminal equipment operating characters of each user displayed in the virtual space, the character of the player on one terminal equipment can communicate with the characters operated by other users on their terminal equipment, the program functioning as; means for associating a character name with an Internet e-mail address of the player on the terminal equipment and recording them in the dedicated server; and means wherein when the terminal equipment of a mail source is connected to the game, an inside-game mail using a character name is received and a character name of a destination is acquired, thereafter if the destination is playing the game at present, then an internal e-mail by the inside-game mail is transmitted as required by the destination, whereas if the destination is not playing the game at present and the Internet e-mail address has been registered, then an Internet e-mail is used to transmit an arrival message addressed to the Internet e-mail address corresponding to the character name and thereafter the inside-game mail is converted to a WEB mail format to perform an external e-mail transmission by a WEB mail addressed to the game character name as required by the destination.

Still further, the present invention provides a program of e-mail community system for a network game, in the multi-participant network game which proceeds by intensively administrating the virtual space shared by a dedicated server and each terminal equipment and by transmission/reception between the dedicated server and the terminal equipment, as the network game proceeds by the players on terminal equipment operating characters of each user displayed in the virtual space, the character of the player on one terminal equipment can communicate with the characters operated by other users on their terminal equipment, the program functioning as means wherein when the terminal equipment of a mail source is connected to a WEB page, an WEB mail using a character name is received and WEB mail is converted into a inside-game mail format and a character name of a destination is acquired, thereafter if the destination is playing the game at present, then an internal e-mail by the inside-game mail is transmitted as required by the destination, whereas if the destination is not playing the game at present, then the inside-game mail is converted to a WEB mail format to perform an external e-mail transmission by a WEB mail addressed to the game character name.

Moreover, the present invention provides a program of e-mail community system for a network game, in the multi-participant network game which proceeds by intensively administrating the virtual space shared by a dedicated server and each terminal equipment and by transmission/reception between the dedicated server and the terminal equipment, as the network game proceeds by the players on terminal equipment operating characters of each user displayed in the virtual space, the character of the player on one terminal equipment can communicate with the characters operated by other users on their terminal equipment, the program functioning as; means for associating a character name with an Internet e-mail address of the player on the terminal equipment and recording them in the dedicated server; and means wherein when the terminal equipment of a mail source is connected to a WEB page, a WEB mail using a character name is received and the WEB mail is converted into an inside-game mail format and a character name of a destination is acquired, thereafter if the destination is playing the game at present, then an internal e-mail by the inside-game mail is transmitted as required by the destination, whereas if the destination is not playing the game at present and the Internet e-mail address has been registered, then an Internet e-mail is used to transmit an arrival message addressed to the Internet e-mail address corresponding to the character name and thereafter the inside-game mail is converted to a WEB mail format to perform an external e-mail transmission by a WEB mail addressed to the game character name as required by the destination.

Further, a computer-readable recording medium on which the above-mentioned program is recorded.

### EFFECTS OF THE INVENTION

As described, the present invention provides the e-mail community system for a network game, in the multi-participant network game which proceeds by intensively administrating the virtual space shared by the dedicated server and each terminal equipment and by transmission/reception between the dedicated server and the terminal equipment, as the network game proceeds by the players on terminal equipment operating characters of each user displayed in the virtual space, the character of the player on one terminal equipment can communicate with the characters operated by other users on their terminal equipment, including the step wherein when the terminal equipment of the mail source is connected to the game, the inside-game mail using the character name is received and the character name of the destination is acquired, thereafter if the destination is playing the game at present, then the internal e-mail by the inside-game mail is transmitted as required by the destination, whereas if the destination is not playing the game at present, then the inside-game mail is converted into the WEB mail format to perform the external e-mail transmission by the WEB mail addressed to the character name. Accordingly, by this e-mail feature acting as an important role of communication in the multi-participant network game, the players on the network game (also referred to as “user”) can have more opportunity for communication, due to the fact that when the e-mail using the character name of the network game is transmitted from inside-game through the dedicated server or the game server, the transmitted e-mail can be addressed to inside- or outside-game based on the playing status of the destination.

In addition, the e-mail community system permits the users to use the character names, thereby avoiding the personal information (e.g. Internet e-mail address of mobile phone) to leak for safe communications.

Also, irrespective of whether the destination is playing the game or not, the e-mail address is automatically converted using the character name of the network game according to the present state (where the user is inside or outside the game) to perform transmission/reception without notifying of the private Internet e-mail address to the opponent.

Also the present invention provides the e-mail community system for the network game, in the multi-participant network game which proceeds by intensively administrating the virtual space shared by the dedicated server and each terminal equipment and by transmission/reception between the dedicated server and the terminal equipment, as the network game proceeds by the players on terminal equipment operating characters of each user displayed in the virtual space, the character of the player on one terminal equipment can communicate with the characters operated by other users on their terminal equipment, including; the step of associating the character name with the Internet e-mail address of the player on the terminal equipment and recording them in the dedicated server; and the step wherein when the terminal equipment of the mail source is connected to the game, the inside-game mail using the character name is received and the character name of the destination is acquired, thereafter if the destination is playing the game at present, then the internal e-mail by the inside-game mail is transmitted as required by the destination, whereas if the destination is not playing the game at present and the Internet e-mail address has been registered, then the Internet e-mail is used to transmit the arrival message addressed to the Internet e-mail address corresponding to the character name and thereafter the inside-game mail is converted to the WEB mail format to perform the external e-mail transmission by the WEB mail addressed to the game character name as required by the destination. Accordingly, by this e-mail feature acting as an important role of communication in the multi-participant network game, the players on the network game (also referred to as “user”) can have more opportunity for communication, due to the fact that when the e-mail using the character name of the network game is transmitted from inside-game through the dedicated server or the game server, the transmitted e-mail can be addressed to inside- or outside-game based on the playing status of the destination.

In addition, the e-mail community system permits the users to use the character names, thereby avoiding the personal information (e.g. Internet e-mail address of mobile phone) to leak for safe communications.

Also, irrespective of whether the destination is playing the game or not, the e-mail address is automatically converted using the character name of the network game according to the present state (where the user is inside or outside the game) to perform transmission/reception without notifying of the private Internet e-mail address to the opponent.

In addition, if the destination is not playing the game, the arrival message is transmitted as the Internet e-mail, so that the destination is notified of the reception of the unread WEB mail at a relatively early stage.

Further, the present invention provides the e-mail community system for the network game, in the multi-participant network game which proceeds by intensively administrating the virtual space shared by the dedicated server and each terminal equipment and by transmission/reception between the dedicated server and the terminal equipment, as the network game proceeds by the players on terminal equipment operating characters of each user displayed in the virtual space, the character of the player on one terminal equipment can communicate with the characters operated by other users on their terminal equipment, including the step wherein when the terminal equipment of the mail source is connected to the WEB page, the WEB mail using the character name is received and the WEB mail is converted into the inside-game mail format and the character name of the destination is acquired, thereafter if the destination is playing the game at present, then the internal e-mail by the inside-game mail is transmitted as required by destination, whereas if the destination is not playing the game at present, then the inside-game mail is converted to the WEB mail format to perform the external e-mail transmission by the WEB mail addressed to the game character name. Accordingly, by this e-mail feature acting as an important role of communication in the multi-participant network game, the WEB mail and inside-game mail use the character names in the mail source and destination fields, not the Internet e-mail which is a private mail address, and are transmitted by the WEB mail from the outside-game through the dedicated game server and by the inside-game mail from the dedicated server to the destination terminal. On this account, the players on the network game can have more opportunity for communication.

In addition, the e-mail community system permits the users to use the character names, thereby avoiding the personal information (e.g. Internet e-mail address of mobile phone) to leak for safe communications.

Also, irrespective of whether the mail source and destination are playing the game or not, the e-mail address is automatically converted using only the character name of the network game according to the present state (where the user is inside or outside the game) to perform transmission/reception without notifying of the private Internet e-mail address to the opponent.

Still further, the present invention provides the e-mail community system for the network game, in the multi-participant network game which proceeds by intensively administrating the virtual space shared by the dedicated server and each terminal equipment and by transmission/reception between the dedicated server and the terminal equipment, as the network game proceeds by the players on terminal equipment operating characters of each user displayed in the virtual space, the character of the player on one terminal equipment can communicate with the characters operated by other users on their terminal equipment, including: the step of associating the character name with the Internet e-mail address of the player on the terminal equipment and recording them in the dedicated server; and the step wherein when the terminal equipment of the mail source is connected to the WEB page, the WEB mail using the character name is received and WEB mail is converted into the inside-game mail format and the character name of the destination is acquired, thereafter if the destination is playing the game at present, then the internal e-mail by the inside-game mail is transmitted as required by the destination, whereas if the destination is not playing the game at present and the Internet e-mail address has been registered, then the Internet e-mail is used to transmit the arrival message addressed to the Internet e-mail address corresponding to the character name and thereafter the inside-game mail is converted to the WEB mail format to perform the external e-mail transmission by the WEB mail addressed to the game character name as required by the destination. Accordingly, by this e-mail feature acting as an important role of communication in the multi-participant network game, the WEB mail and inside-game mail use the character names in the mail source and destination fields, not the Internet e-mail which is a private mail address, and are transmitted by the WEB mail from the outside-game through the dedicated game server and by the inside-game mail from the dedicated server to the destination terminal. On this account, the players on the network game can have more opportunity for communication.

In addition, the e-mail community system permits the users to use the character names, thereby avoiding the personal information (e.g. Internet e-mail address of mobile phone) to leak for safe communications.

Also, irrespective of whether the mail source and destination are playing the game or not, the e-mail address is automatically converted using only the character name of the network game according to the present state (where the user is inside or outside the game) to perform transmission/reception without notifying of the private Internet e-mail address to the opponent.

In addition, when the destination is not playing the game, the arrival message is transmitted as the Internet e-mail, so that the destination is notified of the reception of the unread WEB mail at a relatively early stage.

Also, the present invention provides the program of e-mail community system for the network game, in the multi-participant network game which proceeds by intensively administrating the virtual space shared by the dedicated server and each terminal equipment and by transmission/reception between the dedicated server and the terminal equipment, as the network game proceeds by the players on terminal equipment operating characters of each user displayed in the virtual space, the character of the player on one terminal equipment can communicate with the characters operated by other users on their terminal equipment, the program functioning as means wherein when the terminal equipment of the mail source is connected to the game, the inside-game mail using the character name is received and the character name of the destination is acquired, thereafter if the destination is playing the game at present, then the internal e-mail by the inside-game mail is transmitted as required by the destination, whereas if the destination is not playing the game at present, then inside-game mail is converted into the WEB mail to perform the external e-mail transmission by the WEB mail addressed to the game character name. Accordingly, by this e-mail feature acting as an important role of communication in the multi-participant network game, the players on the network game (also referred to as “user”) can have more opportunity for communication, due to the fact that when the e-mail using the character name of the network game is transmitted from inside-game through the dedicated server or the game server, the transmitted e-mail can be addressed to inside- or outside-game based on the playing status of the destination.

In addition, the e-mail community system permits the users to use the character names, thereby avoiding the personal information (e.g. Internet e-mail address of mobile phone) to leak for safe communications.

Also, irrespective of whether the destination is playing the game or not, the e-mail address is automatically converted using the character name of the network game according to the present state (where the user is inside or outside the game) to perform transmission/reception without notifying of the private Internet e-mail address to the opponent.

Further the present invention provides the program of e-mail community system for the network game, in the multi-participant network game which proceeds by intensively administrating the virtual space shared by the dedicated server and each terminal equipment and by transmission/reception between the dedicated server and the terminal equipment, as the network game proceeds by the players on terminal equipment operating characters of each user displayed in the virtual space, the character of the player on one terminal equipment can communicate with the characters operated by other users on their terminal equipment, the program functioning as: means for associating the character name with the Internet e-mail address of the player on the terminal equipment and recording them in the dedicated server; and means wherein when the terminal equipment of the mail source is connected to the game, the inside-game mail using the character name is received and the character name of the destination is acquired, thereafter if the destination is playing the game at present, then the internal e-mail by the inside-game mail is transmitted as required by the destination, whereas if the destination is not playing the game at present and the Internet e-mail address has been registered, then the Internet e-mail is used to transmit the arrival message addressed to the Internet e-mail address corresponding to the character name and thereafter the inside-game mail is converted to the WEB mail format to perform the external e-mail transmission by the WEB mail addressed to the game character name as required by the destination. Accordingly, by this e-mail feature acting as an important role of communication in the multi-participant network game, the players on the network game (also referred to as “user”) can have more opportunity for communication, due to the fact that when the e-mail using the character name of the network game is transmitted from inside-game through the dedicated server or the game server, the transmitted e-mail can be addressed to inside- or outside-game based on the playing status of the destination.

In addition, the e-mail community system permits the users to use the character names, thereby avoiding the personal information (e.g. Internet e-mail address of mobile phone) to leak for safe communications.

Also, irrespective of whether the destination is playing the game or not, the e-mail address is automatically converted using the character name of the network game according to the present state (where the user is inside or outside the game) to perform transmission/reception without notifying of the private Internet e-mail address to the opponent.

In addition, when the destination is not playing the game, the arrival message is transmitted as the Internet e-mail, so that the destination is notified of the reception of the unread WEB mail at a relatively early stage.

Still further, the present invention provides the program of e-mail community system for the network game, in the multi-participant network game which proceeds by intensively administrating the virtual space shared by the dedicated server and each terminal equipment and by transmission/reception between the dedicated server and the terminal equipment, as the network game proceeds by the players on terminal equipment operating characters of each user displayed in the virtual space, the character of the player on one terminal equipment can communicate with the characters operated by other users on their terminal equipment, the program functioning as means wherein when the terminal equipment of the mail source is connected to the WEB page, the WEB mail using the character name is received and WEB mail is converted into the inside-game mail format and the character name of the destination is acquired, thereafter if the destination is playing the game at present, then the internal e-mail by the inside-game mail is transmitted as required by the destination, whereas if the destination is not playing the game at present, then the inside-game mail is converted to the WEB mail format to perform the external e-mail transmission by the WEB mail addressed to the game character name. Accordingly, by this e-mail feature acting as an important role of communication in the multi-participant network game, the WEB mail and inside-game mail use the character names in the mail source and destination fields, not the Internet e-mail which is a private mail address, and are transmitted by the WEB mail from the outside-game through the dedicated game server and by the inside-game mail from the dedicated server to the destination terminal. On this account, the players on the network game can have more opportunity for communication.

In addition, the e-mail community system permits the users to use the character names, thereby avoiding the personal information (e.g. Internet e-mail address of mobile phone) to leak for safe communications.

Also, irrespective of whether the destination is playing the game or not, the e-mail address is automatically converted using the character name of the network game according to the present state (where the user is inside or outside the game) to perform transmission/reception without notifying of the private Internet e-mail address to the opponent.

Moreover, the present invention provides the program of e-mail community system for the network game, in the multi-participant network game which proceeds by intensively administrating the virtual space shared by the dedicated server and each terminal equipment and by transmission/reception between the dedicated server and the terminal equipment, as the network game proceeds by the players on terminal equipment operating characters of each user displayed in the virtual space, the character of the player on one terminal equipment can communicate with the characters operated by other users on their terminal equipment, the program functioning as; means for associating the character name with the Internet e-mail address of the player on the terminal equipment and recording them in the dedicated server; and means wherein when the terminal equipment of the mail source is connected to the WEB page, the WEB mail using the character name is received and the WEB mail is converted into the inside-game mail format and the character name of the destination is acquired, thereafter if the destination is playing the game at present, then the internal e-mail by the inside-game mail is transmitted as required by the destination, whereas if the destination is not playing the game at present and the Internet e-mail address has been registered, then the Internet e-mail is used to transmit the arrival message addressed to the Internet e-mail address corresponding to the character name and thereafter the inside-game mail is converted to the WEB mail format to perform the external e-mail transmission by the WEB mail addressed to the game character name as required by the destination. Accordingly, by this e-mail feature acting as an important role of communication in the multi-participant network game, the WEB mail and inside-game mail use the character names in the mail source and destination fields, not the Internet e-mail which is a private mail address, and are transmitted by the WEB mail from the outside-game through the dedicated game server and by the inside-game mail from the dedicated server to the destination terminal. On this account, the players on the network game can have more opportunity for communication.

In addition, the e-mail community system permits the users to use the character names, thereby avoiding the personal information (e.g. Internet e-mail address of mobile phone) to leak for safe communications.

Also, irrespective of whether the destination is playing the game or not, the e-mail address is automatically converted using the character name of the network game according to the present state (where the user is inside or outside the game) to perform transmission/reception without notifying of the private Internet e-mail address to the opponent.

In addition, when the destination is not playing the game, the arrival message is transmitted as the Internet e-mail, so that the destination is notified of the reception of the unread WEB mail at a relatively early stage.

### BEST MODE FOR CARRYING OUT THE INVENTION

By such invention, means for associating the character name with the Internet e-mail address of the player on the terminal equipment and recording them in the dedicated server; and means wherein when the terminal equipment of the mail source is connected to the game or the WEB page, the mail using the character name is received from the mail source, thereafter if the mail source is playing the game at present, then the internal e-mail by the inside-game mail is transmitted, whereas if the mail source is not playing the game at present, then the WEB mail is converted into the inside-game mail format and the character name of the destination is acquired thereafter if the destination is playing the game at present, then the internal e-mail by the inside-game mail is transmitted, whereas if the destination is not playing the game at present and the Internet e-mail address has been registered, then the Internet e-mail is used to transmit the arrival message addressed to the Internet e-mail address corresponding to the character name and thereafter the inside-game mail is converted to the WEB mail format to perform the external e-mail transmission by the WEB mail addressed to the game character name. Accordingly, when the e-mail is transmitted from inside-game through the dedicated server or the game server, the transmitted e-mail can be addressed to inside- or outside-game based on the playing status of the destination. The WEB mail and inside-game mail use the character names in the mail source and destination fields, not using the Internet e-mail which is a private mail address, and are transmitted by the WEB mail from the outside-game through the dedicated game server and by the inside-game mail from the dedicated server to the destination terminal. On this account, the players on the network game can have more opportunity for communication.

An embodiment of the present invention is described in detail as follows with reference to the drawings.

FIGS. 1-14 illustrate the embodiment of the present invention. FIGS. 3-6 show an e-mail community system 2 of a multi-participant MMORPG network game.

In this multi-participant MMORPG network game, a dedicated server 4 (also referred to as “network game server”, “game server”, or just “server”) intensively administrates the virtual space shared by the server and each terminal equipment (also referred to as “PC” which includes personal computer, mobile phone, PDA, and the like in the present invention), and proceeds the game by performing transmission/reception among the dedicated server 4 and respective terminal equipment (e.g. a first terminal equipment 6 of a player 1 and a second terminal equipment 8 of a player 2).

In the multiple-participant network game as the network game proceeds by operating e.g. a character 1 displayed in the virtual space as an avatar representing the player 1 of the first terminal equipment 6, the e-mail community system 2 permits the player 1 on the first terminal equipment 6 to communicate with other character operated by e.g. the player 2 of the second terminal equipment 8 using a dedicated e-mail address that can be used only inside the network game, that is a communication between the characters.

As shown in FIGS. 3-6, the structure of the MMORPG network game includes on an Internet 10; a first Internet service provider (“ISP1”) 12 under contract with the player 1 operating the first terminal equipment 6; a second Internet service provider (“ISP2”) 14 under contract with the player 2 operating the second terminal equipment 8; a third Internet service provider (“ISP3”) 16 under contract with a network game provider (not shown) possessing the dedicated server 4; a first mail server (“mail server 1”) 18 connected to the first Internet service provider 12; a second mail server (“mail server 2”) 20 connected to the second Internet service provider 14; and a third mail server (“mail server 3”) 22 connected to the dedicated server 4.

Although it is described herein that the third Internet service provider (“ISP3”) 16 is under contract with the network game provider (not shown) possessing the dedicated server 4, the network game provider may act as the third Internet service provider 16.

To the Internet 10, a mobile terminal 26 can also connect through a public line network 24. Incidentally, FIGS. 3-6 shows the public line network as routing through the ISP 1 of the PC of the player 1. This is indicated just for convenience and it is needless to say that the public network line need not routing therethrough. Same applies to the ISP 2 of the PC of the player 2.

The e-mail community system 2 is configured to include the steps of: associating a character name with an Internet e-mail address of the player on the terminal equipment and recording them in the dedicated server 4; and a step wherein when the terminal equipment of a mail source is connected to the game, an inside-game mail using a character name is received and a character name of a destination is acquired, thereafter if the destination is playing the game at present, then an internal e-mail by the inside-game mail is transmitted as required by the destination, whereas if the destination is not playing the game at present and the Internet e-mail address has been registered, then an Internet e-mail is used to transmit an arrival message addressed to the Internet e-mail address corresponding to the character name and thereafter the inside-game mail is converted to a WEB mail format to perform an external e-mail transmission by a WEB mail addressed to the game character name as required by the destination.

In addition, the e-mail community system 2 is configured to include the steps of; associating a character name with an Internet e-mail address of the player on the terminal equipment and recording them in the dedicated server 4; and a step wherein when the terminal equipment of a mail source is connected to a WEB page, a WEB mail using a character name is received and the WEB mail is converted into an inside-game mail format and a character name of a destination is acquired, thereafter if the destination is playing the game at present, then an internal e-mail by the inside-game mail is transmitted as required by the destination, whereas if the destination is not playing the game at present and the Internet e-mail address has been registered, then an Internet e-mail is used to transmit an arrival message addressed to the Internet e-mail address corresponding to the character name and thereafter the inside-game mail is converted to a WEB mail format to perform an external e-mail transmission by a WEB mail addressed to the game character name as required by the destination.

More particularly, in the embodiment of the present invention, the privacy is protected by using only the character name of the game instead of the Internet e-mail address.

As shown in FIG. 1, it is only at the first time of the transmission (of the arrival message) to the outside-game address that the e-mail is transmitted using the registered private Internet e-mail address in mail address and destination fields in a mail source field of the dedicated server 4. Opponent's Internet e-mail address is not utilized at all.

There are basic communication modes in the e-mail community system 2 as follows;

(1) e-mail transmission from the user PC playing the game (e.g. first and second terminals 6 and 8) to the mobile terminal 26 (e.g. mobile phone) not playing the game; and
(2) e-mail transmission from the mobile phone 26 not playing the game to the user PC playing the game.

For the case of (1) e-mail transmission from the user PC to the mobile terminal, firstly the inside-game mail is transmitted from the user PC to the game server.

That is, the communication “a” in FIG. 1 is an Internet communication by the WWW (not using the browser), which is transmitted/received utilizing a protocol unique to the game similarly to the game data and the game commands.

The transmitted/received data can be in any format.

Identification of the terminal is made from the IP address, and identification of the game user is made from not the e-mail address but the account ID that is registered and received beforehand.

The communication system of the present invention does not route through the mail server on the communication passage as in the standard ordinal e-mail, and uses the character name in the mail source and destination fields, not using the Internet e-mail address.

Then the game server transmits the message (arrival message) in the ordinal e-mail format (mail source: gameserver@koei.co.jp, destination: ueno@doco.co.jp) to the mobile terminal 26 outside the game (see communication “b” in FIG. 1).

At this moment, the destination is a private Internet e-mail address which has been already registered and the mail source is the mail address of the game server. Only this time, the e-mail in the ordinal e-mail format is transmitted.

The e-mail is received by the terminal 26 through the mail server connected to the dedicated server 4 or the game server, the mail server of the ISP, and the public line network 24. The data format of the mail data is a certain format compliant with the e.g. RFC822.

FIG. 2 illustrates a screen for indicating the arrival message in transmission “b” in FIG. 1.

On the mobile terminal 26 side, when a displayed hyperlink “http://www.koei.co.jp/ . . . /” is selected, the browser is launched in the known manner to access to such URL (Uniform Resource Locator). The mobile terminal 26 is thereby connected to the dedicated WEB page in the game server. Then as required by the mobile terminal 26, the game server transmits, to the mobile terminal as the WEB mail, the inside-game mail which was previously received from the user PC.

A communication “c” in FIG. 1 for such communication involves the WEB mail, which is an Internet communication by the WWW. In contrast to the communication “a” in FIG. 1, in the communication “c” the browser is launched simultaneously with the access to the URL and the mail in an HTML format is transmitted/received using the HTTP protocol.

As with the communication “a”, the mail address is not used; the mail server is not routed through.

As with the communication “a”, the character names are used in the mail source and destination fields.

Incidentally, the above hyperlink in the arrival message is assumed to have been set in the known manner.

(2) In the case of voluntary transmission of the e-mail from the mobile terminal 26 to the user PC, the mobile terminal 26 accesses to “http://www.koei.co.jp/ . . . /” and the user is identified from the transmitted account ID, so as to establish the communication “c” (WEB mail) and the communication “a” (inside-game mail) in FIG. 1, which is an opposite direction.

Just for reference, the reason why the main body of the e-mail is transmitted by the WEB mail instead of the Internet e-mail is that there is limit of the characters, 256 characters in the main body of the mail, which the mobile terminal 26 can sent by the mobile e-mail system (I-Mode™).

As shown in FIG. 3, for the ordinal inside-game mail (“UENO” to “ERI”) in the e-mail community system 2, the dedicated server 4 and the first and second terminals 6 and 8 are respectively connected by the WWW.

At this moment, the first Internet service provider (ISP1) 12 under contract with the player 1 operating the first terminal equipment 6 and the first mail server (e-mail serer 1) 18 are disconnected. Also, the second Internet service provider (ISP2) 14 under contract with the player 2 operating the second terminal equipment 8 and the second mail server (e-mail serer 2) 20 are disconnected.

More particularly, for the ordinal inside-game mail (from “UENO” to “ERI”), the e-mail transmitted/received inside of the network game is not, in fact, the Internet e-mail (also simply referred to as “e-mail”), but an Internet communication (inside-game mail) through the WWW using the protocol unique to the game.

As shown in FIG. 4, for the transmission of e-mail from inside to outside-game (“UENO” to “eri@”) in the e-mail community system 2, the dedicated server 4 and the first terminal 6 are connected through the WWW. Between the dedicated server 4 and the second terminal 8, the arrival message is firstly transferred utilizing the Internet e-mail by the second and third ISPs 14 and 16, and thereafter the WEB mail is utilized for the connection therebetween by through the WWW (latter communication not shown)

At this moment, the first Internet service provider (ISP1) 12 under contract with the player 1 operating the first terminal equipment 6 and the first mail server (e-mail serer 1) 18 are disconnected. In contrast, the second Internet service provider (ISP2) 14 under contract with the player 2 operating the second terminal equipment 8 and the second mail server (e-mail serer 2) 20 are connected when receiving the arrival message, but they are disconnected when receiving the subsequent WEB messages (not shown).

That is, for the e-mail transmitted from inside game to outside game (from “UENO” to “eri@”), the e-mail is transferred from the player 1 to the KOEI's game server as the Internet communication data through the WWW (inside-game mail) not as the Internet e-mail, whereas the arrival message is transferred from the mail server 3 which belongs to the KOEI's game server to the player 2 as the Internet e-mail, and the subsequent WEB mails having the same contents as the foregoing inside-game mail are transferred from the KOEI's game server to the player 2 (latter not shown).

As shown in FIG. 5, for the e-mail from the outside-game to inside-game (from “UENO@” to “ERI”) in the e-mail community system 2, the WEB mail is transmitted from the first terminal equipment 6 to the dedicated server 4 through the WWW, and the inside-game mail is transmitted from the dedicated server 4 and the second terminal equipment 8 through the WWW.

At this moment, the first Internet service provider (ISP1) 12 under contract with the player 1 operating the first terminal equipment 6 and the first mail server (e-mail server 1) 18 are disconnected. Also the second Internet service provider (ISP2) 14 under contract with the player 2 operating the second terminal equipment 8 and the second mail server (e-mail serer 2) 20 are disconnected.

More particularly, for the e-mail transmitting from the inside-game to outside-game (from “UENO” to “ERI”), the mail is transmitted from the player 1 to the game server of KOEI as the Internet communication (WEB mail) through the WWW by the HTTP (Hyper Text Transfer Protocol; through which browsers display the web pages), not as the Internet e-mail. Then the e-mail is transmitted from the KOEI's game server to the player 2 as the Internet communication (inside-game mail) through the WWW by a protocol unique to the game. HTTP is a protocol between the server providing the information and the client receiving the information, which is a set of basic rules for exchanging the hyper text such as web pages, whereas the browser is an application software for viewing the web pages.

As shown in FIG. 6, for the e-mail from the outside-game to outside-game (from “UENO” to “eri@”) in the e-mail community system 2, the WEB mail is transmitted from the first terminal equipment 6 to the dedicated server 4 through the WWW, then the arrival message is transmitted from the dedicated server 4 to the second terminal equipment 8 as the Internet e-mail from the mail server 3 of the dedicated server 4, not using the WWW. Thereafter, the WEB mail is transmitted by connection through the WWW between the dedicated server 4 to the second terminal equipment 8 (this connection not shown).

At this moment, the first Internet service provider (ISP1) 12 under contract with the player 1 operating the first terminal equipment 6 and the first mail server (e-mail server 1) 18 are disconnected. The second Internet service provider (ISP2) 14 under contract with the player 2 operating the second terminal equipment 8 and the second mail server (e-mail serer 2) 20 are connected when receiving the arrival message, but are disconnected when receiving the subsequent WEB mails (latter not shown).

More particularly, for the e-mail transmitting from the outside-game to outside-game (from “UENO” to “eri@”), the mail is transmitted from the player 1 to the game server of KOEI as the Internet communication (WEB mail) through the WWW by the HTTP (Hyper Text Transfer Protocol, through which browsers display the web pages), not as the Internet e-mail. Then the arrival message is transmitted from the mail server 3 of the KOEI's game server to the player 2 as the Internet e-mail, and subsequent WEB mails having the same content as the prior WEB mail are transferred from the KOEI's game server to the player 2 (latter not shown).

Here, the explanation is provided as to an initial registration of the e-mail community system 2 required to initiate the MMORPG network game.

In this initial registration, term “inside-game” is referred to as “playing the game”, “outside-game” as “not playing the game”.

(1) In this initial registration, the player 1 (e.g., Ueno) who is operating the first terminal equipment 6 and the player 2 (e.g., Erikawa) who is operating the second terminal equipment 8 are respectively required to register the outside-game addresses (Internet address) to the e-mail community system 2 for the MMORPG network game in advance (for example, Ueno Is outside-game address is ueno@doco.co.jp, and Erikawa's outside-game address is eri@doco.co.jp).
(2) Inside the game, for example Ueno's character name is “UENO”, and Erikawa's character name is “ERI”.

The game system stores (in a mail address table) the correlation or association of the game character name with the private Internet e-mail address.

A plurality of character may be provided for a single private Internet e-mail address.

The status of transmission in the e-mail community system 2 are classified as follows.

For the case of transmission of e-mail from outside-game (see FIGS. 9(a) and 10(a)):

(3) When Ueno outside the game sends e-mail to Erikawa, making a prediction that Erikawa may be inside the game right now, the description of the addresses should be as follows.
Mail source (sender): UENO
Destination (receiver): ERI

At this moment, Ueno voluntarily accesses to the page for issuing WEB mail at “http:www.koei.co.jp/ . . . /” using the game account ID and selects the character for drafting the e-mail (here the game system recognizes Ueno's character name as UENO).

Then list of game characters friendly to the selected character (character name: UENO) are searched in the game system and displayed (friend list).

From the list, Ueno selects the character name “ERI” of Erikawa and enters the main body of the e-mail and transmits the e-mail.

In the mail issuing page, the messages can be exchanged using only the character names, without concerning the addresses of the mail source and private e-mail destination address.

Incidentally, term “koei” used herein derives from the registered trademark owned by the applicant (Japanese trademark registration No. 4,417,393).

(4) The game system prepares to transmit the inside-game mail from UENO, which is the Ueno's character, to ERI, which is Erikawa's character, irrespective of access from the outside the game.
(5) Then the game system checks the destination.

The game system checks whether destination Erikawa is inside the game (playing the game) at present or not.

(6) If this check result is positive (Erikawa is playing the game), the e-mail is transmitted (see FIG. 9(b)).

### (Inside-Game Mail)

Erikawa inside the game receives the e-mail from Ueno outside the game (transmission outside-game to inside-game).
Mail source (sender): UENO
Destination (receiver): ERI

At this moment, receiver Erikawa is not notified of the sender Ueno's outside-game address (“ueno@doco.co.jp”).

Sender Ueno is not notified of the receiver Erikawa's outside-game address (“eri@doco.co.jp”), either.

(7) If the check result is negative (Erikawa is not playing the game), the destination outside-game address of ERI (Erikawa) is searched in the game system and the arrival message is firstly transmitted as the e-mail (see FIG. 10(b)).

### (Arrival Message, Internet E-Mail)

Erikawa outside the game receives the arrival message as the e-mail from Ueno outside the game (transmission from outside-game to outside-game).

The game server sets its mail address in the mail source field, and sets “eri@doco.co.jp”, which is registered for the character ERI, in the destination field.

In the arrival message, the text “from UENO” is included.
Mail source (sender): gameserver@koei.co.jp
Destination (receiver): eri@doco.co.jp

At this moment, receiver Erikawa is not notified of the sender Ueno's outside-game address (“ueno@doco.co.jp”).

Sender Ueno is not notified of the receiver Erikawa's outside-game address (“eri@doco.co.jp”), either.

After reception of the arrival message, Erikawa accesses to the dedicated WEB page in the game server by selecting the URL (http:// . . . ) in FIG. 10(b) to receive the e-mail from Ueno as the WEB mail from the game server.

For the case of transmission from inside-game (see FIGS. 7(a) and 8(a), it is noted that the sender and receiver are inverted).

(8) When Erikawa inside the game sends e-mail to Ueno, making a prediction that Ueno may be inside the game right now, the description of the addresses should be as follows.

### (Inside-Game Mail)

Mail source (sender): ERI
Destination (receiver): UENO

This is the case where Erikawa knows Ueno's game character name “UENO”.

As with the transmission of the e-mil inside the game, the e-mail is transmitted to the character “UENO”. Erikawa does not need to know Ueno's outside-game address “ueno@doco.co.jp” or not concern about reception of the mail from outside the game.

(9) The game system checks the destination.

### (Inside-Game Mail)

The game system checks whether the destination Ueno is inside the game (playing the game).

(10) If the check result is positive (Ueno is playing the game at present), the e-mail is transmitted as the inside-game mail (see FIG. 7(b)).

Ueno inside the game receives the e-mail from Erikawa inside the game (transmission from inside-game to inside-game).
Mail source (sender): ERI
Destination (receiver): UENO
   (11) If the check result is negative (Erikawa is not playing the game), the destination outside-game address of ERI (Erikawa) is searched in the game system and the arrival message is firstly transmitted as the e-mail (see FIG. 8(b)).

### (Arrival Message, Internet E-Mail)

Ueno outside the game receives the arrival message as the e-mail from Erikawa inside the game (transmission from inside-game to outside-game).

The game server sets its mail address in the mail source field, and sets “ueno@doco.co.jp”, which is registered for the character UENO, in the destination field.

In the arrival message, the text “from ERI” is included.
Mail source (sender): gameserver@koei.co.jp
Destination (receiver): ueno@doco.co.jp

At this moment, receiver Ueno is not notified of the sender Erikawa's outside-game address (“eri@doco.co.jp”).

Sender Erikawa is not notified of the receiver Ueno's outside-game address (“ueno@doco.co.jp”), either.

After reception of the arrival message, Ueno accesses to the dedicated WEB page in the game server by selecting the URL (http;// . . . ) in FIG. 8(b) to receive the e-mail from Erikawa as the WEB mail from the game server.

Here, since the private Internet e-mail address (outside-game address) is associated with each character, it exactly looks like the characters inside the game exchanging the mails when the users voluntarily access to the dedicated WEB page at the foregoing URL to select the character for transmitting the WEB mail.

If the character of the destination is not playing the game, the arrival message is transmitted as the Internet e-mail while automatically using the registered outside-game e-mail address. If the mail system in the game allows multiple transmission to more than one characters, multiple mail transmission to the outside-game is achievable. That is, when more than one character name is set as the destination and the e-mails are transmitted, the inside-game mail using the character name is transmitted to the character playing on the PC, while the arrival message using the outside-game address corresponding to the character not playing the game and WEB mail using the character name and having the same contents is transmitted to the character not playing the game.

What is displayed on the screen in proceeding by the e-mail community system 2 is explained as follows.

(1) Transmission of E-Mail from Inside-Game to Inside-Game

As shown in FIG. 7(a), the Ueno's terminal displays the screen for transmission of the inside-game mail in gaming as follows.
From: UENO
To: ERI
Subject: . . .

The e-mail is stored in the mail boxes of the mail source (sender) “UENO” and the destination (receiver) “ERI” in the dedicated server or the game server. As shown in FIG. 7(b), the Eri's terminal displays the screen for reception of the inside-game mail in gaming as follows.
From: UENO
To: ERI
Subject: . . .
   (2) Transmission of E-Mail from Inside-Game to Outside-Game

As shown in FIG. 8(a), the Ueno's terminal displays the screen for transmission of the inside-game mail in gaming as follows.
From: UENO
To: ERI
Subject: . . .

As shown in FIG. 8(b), the Eri's terminal displays the screen for reception of the outside-game mail (Internet e-mail) by the mailer as follows:
From: gameserver@koei.co.jp
To: eri@doco.co.jp
Subject: . . .
“You have received the message from UENO.
Please select: http://www.koei.co.jp/ . . . /”

In the screen of the inside-game mail, designation can be made as the character name, so that the user does not bother entering the address for the e-mail.

(3) Transmission of E-Mail from Outside-Game to Inside-Game Mail

As shown in FIG. 9(a), the Ueno's terminal displays the screen for transmission of the outside-game mail (WEB mail) on the WEB page as follows.
From: UENO
To: ERI
Subject: . . .

As shown in FIG. 9(b), the Eri's terminal displays the screen for reception of the inside-game mail in gaming as follows, similarly to the screen on the Ueno's terminal for transmission of the outside-game mail (WEB mail) on the WEB page.
From: UENO
To: ERI
Subject: . . .
   (4) Transmission of E-Mail from Outside-Game to Outside-Game

As shown in FIG. 10(a), the Ueno's terminal displays the screen for transmission of the outside-game mail (WEB mail) on the WEB page as follows.
From: UENO
To: ERI
Subject:

As shown in FIG. 10(b), the Eri's terminal displays the screen for reception of the outside-game mail (Internet e-mail) by the mailer as follows.
From: gameserver@koei.co.jp
To: eri@doco.co.jp
Subject: . . .
“You have received the message from UENO.
Please select: http://www.koei.co.jp/ . . . /”

Although this is the transmission from outside-game to outside-game, the WEB mail is transmitted from the mail source routing through the server. On this account, the arrival message can be transmitted at the server as the Internet e-mail using the mail source of the server's mail address and the destination of registered e-mail address associated with the character.

The mail from the outside-game can be transmitted on the screen for transmission of the mail on the WEB page.

The user does not use the mail but the browser, so that the Internet e-mail address is not disclosed to the opponent user. (5) FIG. 11 illustrates states of registration of user account and status of user playing the game stored in the game server. A mail address table stores, as the user account registration state, the outside-game address, account ID, and the usable character names, and updates and stores, as the user playing status, game starting time and finish time for the user or the character. This update is achieved by receiving and memorizing the information indicating that the user is playing the game at the beginning of the game, and receiving the information indicating that the game is ended at the end of the game, followed by erasing the information indicating that the user is playing. The outside-game address is the Internet e-mail address, which can be referred to as “private e-mail address” in other words.

The operation of a process for user initial registration by the game server is explained below with reference to a flowchart for the user initial registration in FIG. 12.

A program of the mail community system 2 for the initial registration starts at step 100, and a process for reception of the game account ID and for connection is performed at step 102. In this step 102, the game account ID such as follows is received.
Ueno's account ID: “aaaaaaaa”
Erikawa's account ID: “bbbbbbbb”

Then the program shifts to a process for reception of the character name at step 104. In this step 104, the character name such as follows is received.
Ueno's character name: UENO
Erikawa's character name: ERI

Following the step 104, the outside-game address is registered at step 106 for the outside-game address registration as follows.
Ueno's outside-game address: ueno@doco.co.jp
Erikawa's outside-game address: eri@doco.co.jp

Then the program goes to a step 108 for storing the character name and the outside-game address. In this step 108, the outside-game address (private e-mail address), the account ID, and the character name are correlated or associated at the mail address table shown in FIG. 11 as follows.
UENO/ueno@doco.co.jp
ERI/eri@doco.co.jp

Following the step 108, a process for generating the mail box is performed at step 110 and a process for initial registration finish is performed at step 112.

Just for reference as to registration of the e-mail address, the user at first needs to register for a user registration in order to play the network game.

The use registration is required only at the first time the user plays the game, and the private information of the user is recorded in the game server of the game supplier.

In particular, at the first time the user plays the game, the user's terminal displays the screen for a user account registration (not shown).

Following the displayed instructions, the user enters the private information such as address, sex, and age as well as the outside-game address, and then selects a character that can be operated in gaming (player character) to meet the user's taste. The entered information is transmitted to the game server.

The game server receives the information and initiates for the process of the user initial registration.

The game server associates the received character name of the player character with its outside-game address and stores this association in the database. The game server then generates the mail boxes, in the mail server and the game server, associated with the character name as the inside-game address. The user on the terminal is notified of the inside-game address by transmission of such information, and will be able to use the inside-game address and operate the selected player character in the subsequent game.

The present invention is explained as permitting the user to select only a single player character and as correlating a single outside-game address with a single issued inside-game address. However, the present invention is not limited to this and many characters can be selected at the same time.

When the user is allowed to select more than one player character at the same time, more than one character name as the inside-game address must be issued.

However, the outside-game address is proper to the user, so that it requires plural correlations between the inside- and outside-game addresses, which makes it impossible to identify the player character when using only the outside-game address.

On this account, by indicating the character name as the mail source and the destination the subject field or the main body of the e-mail, the user can distinguish which character of the player sent the e-mail even if the outside-game addresses are used in the mail source and destination fields. Alternatively, by issuing a particular account ID proper to the player, instead of the character name and by indicating the character name as an actual mail source and the destination in the subject field or the main body of the e-mail, the user can distinguish which character of the player sent the e-mail even if the character names are used in the mail source and destination fields.

Operation of a routine process of the game server is explained as follows with reference to a flowchart of a mail process in FIG. 13.

After a program of the mail community system 2 for the mail process starts at step 200, a process for the game and connection to the WEB page is performed at step 202.

Following the step 202, a process for obtaining the account ID at step 204, a process for searching the data in the server at step 206 are performed. Then a determination is made at step 208 as to whether the account ID is valid (registered).

If the determination at step 208 is “YES” (e.g. the account ID is “aaaaaaaa”), a process for reception of the e-mail is performed at step 210. If the determination at step 208 is “NO” (e.g. the account ID is unregistered “cccccccc”, “dddddddd”, or “eeeeeeee”), then a process to return for an error is performed at step 212. At this moment, the step 212 indicates that a state the user does not participate in the game (i.e. unregistered state).

Following the step 210, a process for obtaining the character of the mail source (“UENO”) is performed at step 214. Then a determination is made at step 216 as to whether the character of the mail source is playing the game.

If the determination at step 216 is “YES” (the character of the mail source is inside the game), a program continues to follow a flowchart in FIG. 14. If the determination at step 216 is “NO” (i.e. the e-mail is in the WEB mail format), a process for converting the data format into the inside-game mail format is performed at step 218, and the program continues to follow the flowchart in FIG. 14.

The explanation is made with reference to the flowchart in FIG. 14.

In the flowchart in FIG. 14, a process for obtaining the friend list is performed at step 300, followed by a process for obtaining the character of the destination at step 302. Then a determination is made at step 304 as to whether the destination character is friendly or not. Here whether the character is friendly can be selected in another scene (not shown) in the game and the server stores the association in a friend list. This process regarding the friend list may be omitted if single destination character name can be identified.

If the determination at step 304 is “YES”, then another determination is made at step 306 as to whether the destination character is playing the game. If the determination at step 304 is “NO”, a process to return for error is performed at step 308. This step 308 indicates a state where the destination character is not opponent to which mail can be sent.

If the determination at step 306 is “YES”, a process for the internal mail transmission is performed at step 310 as required by the user of the destination, followed by a process for return at step 320. If the determination at step 306 is “NO”, then a process for the data search of the outside-game e-mail address of the destination in the server. Then a determination is made at step 314 as to whether the outside-game e-mail address is a registered one. Here the requirement of the user reefers to the case, e.g., the user selected “to display the unread mails” in a dedicated screen (not shown).

If the determination at step 314 is “YES” (e.g. the outside-game address associated with the character name (such as ERI/eri@doco.co.jp) is a registered one), then the arrival message is transmitted at step 316 as having the destination address of this outside-game e-mail address and mail source of this mail address. After the destination user (ERI) selected the URL for connecting to the dedicated WEB page for the web mail, a process for converting the prior inside-game mail into the WEB mail data format and transmitting it as WEB mail is performed at step 317 as required by the destination, followed by a process to return at step 320. If the determination at step 314 is “NO”, then a process for storing the internal mail is performed at step 318 (this is recognized as an error since the destination is unregistered), followed by the process to return at step 320.

Accordingly, by this e-mail feature acting as an important role of communication in the multi-participant network game, the players on the network game (also referred to as “user”) can have more opportunity for communication, due to the fact that when the e-mail using the character name of the network game is transmitted from inside-game through the dedicated server or the game server, the transmitted e-mail can be addressed to inside- or outside-game based on the playing status of the destination.

In addition, the e-mail community system permits the users to use the character names, thereby avoiding the personal information (e.g. Internet e-mail address of mobile phone) to leak for safe communications.

Also, irrespective of whether the destination is playing the game or not, the e-mail address is automatically converted using the character name of the network game according to the present state (where the user is inside or outside the game) to perform transmission/reception without notifying of the private Internet e-mail address to the opponent.

Accordingly, by this e-mail feature acting as an important role of communication in the multi-participant network game, the WEB mail and inside-game mail use the character names in the mail source and destination fields, not the Internet e-mail which is a private mail address, and are transmitted by the WEB mail from the outside-game through the dedicated game server and by the inside-game mail from the dedicated server to the destination terminal. On this account, the players on the network game can have more opportunity for communication.

In addition, the e-mail community system permits the users to use the character names, thereby avoiding the personal information (e.g. Internet e-mail address of mobile phone) to leak for safe communications.

Also, irrespective of whether the destination is playing the game or not, the e-mail address is automatically converted using the character name of the network game according to the present state (where the user is inside or outside the game) to perform transmission/reception without notifying of the private Internet e-mail address to the opponent.

The present invention is not limited to above-mentioned embodiment and the modifications and changes can be made.

For example, in the MMORPG network game, in communicating the player 1 operating the first terminal who plays a key role in the network game with the player 2 operating the second terminal, the embodiment of the present invention provides the structure in which the two terminal (first and second terminals) are connected to the dedicated server provided by the network game provider. Due to the fact that many players can join the game in the MMORPG network game, a system for communication among more than three characters is achievable when a third terminal and others are connected to the dedicated server.

It is apparent that not only the players 1 and 2 but also three or more players can join the game, since a number of players, such as thousands player, can join the game in the network game of the MMORPG type. One can make a prediction that many characters joined the game communicate each other.

Accordingly, the opportunity for communication among more than three players increases without limitation to the number of the players who can join the game, which contributes to activation of the network game of the MMORPG type. The e-mail community system converts the Internet e-mail address (private e-mail address) and the dedicated e-mail address containing the inside-game character ID to prevent the private information of the three or more players from leaking.

### BRIEF DESCRIPTION OF THE DRAWINGS

FIG. 1 is a schematic diagram showing an embodiment of the present invention.

FIG. 2 is a diagram showing a screen of an arrival message by a communication “b”.

FIG. 3 is a schematic diagram of ordinal inside-game mail (from UENO to ERI).

FIG. 4 is a schematic diagram of inside-game to outside-game transmission (from UENO to eri@).

FIG. 5 is a schematic diagram of outside-game to inside-game transmission (from UENO to ERI).

FIG. 6 is a schematic diagram of outside-game to outside-game transmission (from UENO to eri@).

FIG. 7 is a schematic illustration for inside to inside-game transmission, wherein FIG. 7(a) shows a screen for inside-game mail transmission displayed in gaming on Ueno's terminal, and FIG. 7(b) shows a screen for inside-game mail reception displayed in gaming on Eri's terminal.

FIG. 8 is a schematic illustration for inside to outside-game transmission, wherein FIG. 8(a) shows a screen for inside-game mail transmission displayed in gaming on Ueno's terminal, and FIG. 8(b) shows a screen for outside-game mail (Internet e-mail) reception displayed by the mailer on Eri's terminal.

FIG. 9 is a schematic illustration for outside to inside-game transmission, wherein FIG. 9(a) shows a screen on Ueno's terminal for outside-game mail (WEB mail) transmission on the WEB page, and FIG. 9(b) shows a screen on Eri's terminal for inside-game mail reception displayed in gaming.

FIG. 10 is a schematic illustration for outside to outside-game transmission, wherein FIG. 10(a) shows a screen on Ueno's terminal for outside-game mail (WEB mail) transmission on the WEB page, and FIG. 10(b) shows a screen on Eri's terminal for outside-game mail (Internet e-mail) reception displayed by the mailer.

FIG. 11 is a diagram showing a status of user account registration and playing state of the user.

FIG. 12 is a flowchart for initial registration.

FIG. 13 is a flowchart for a mail process.

FIG. 14 is a flowchart for the process for the inside-game mail (including the converted ones).

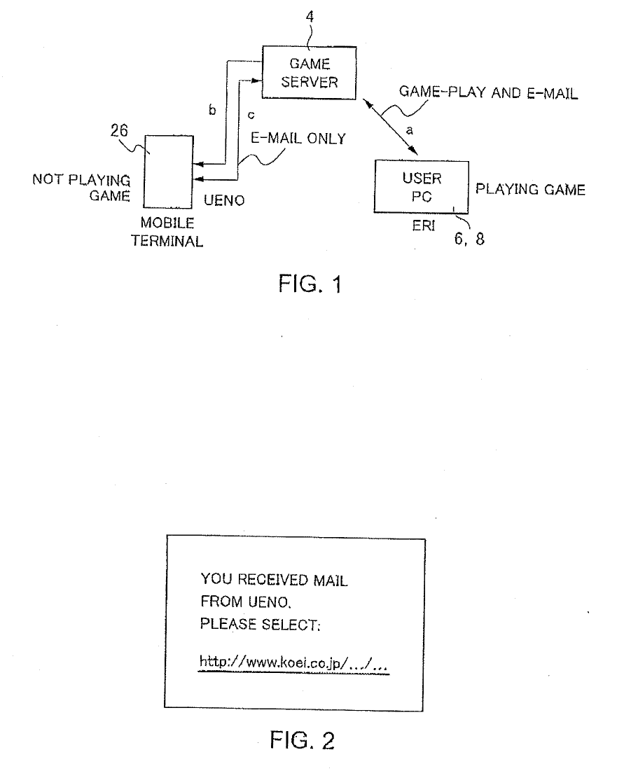

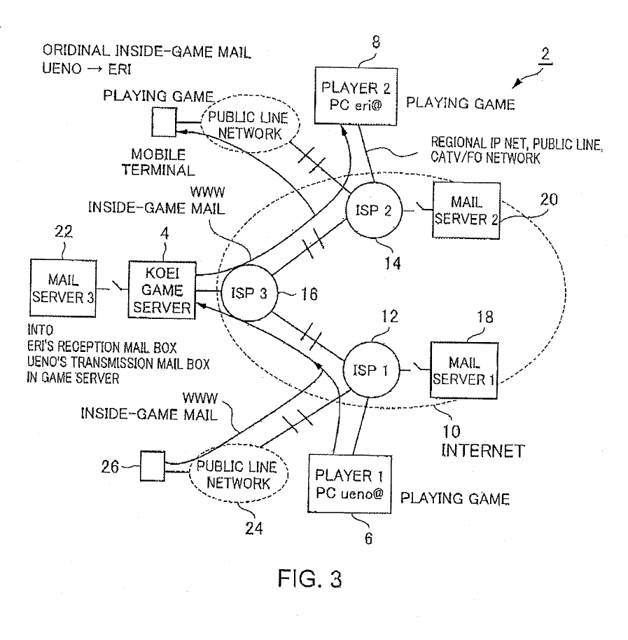

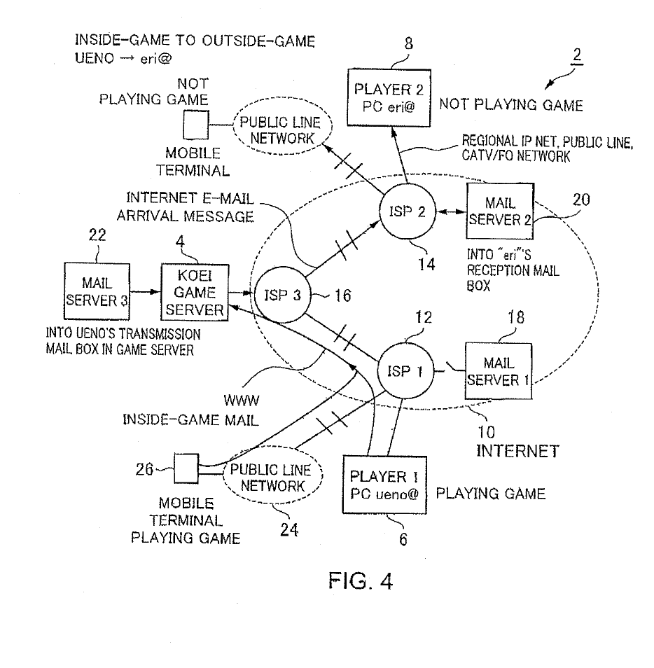

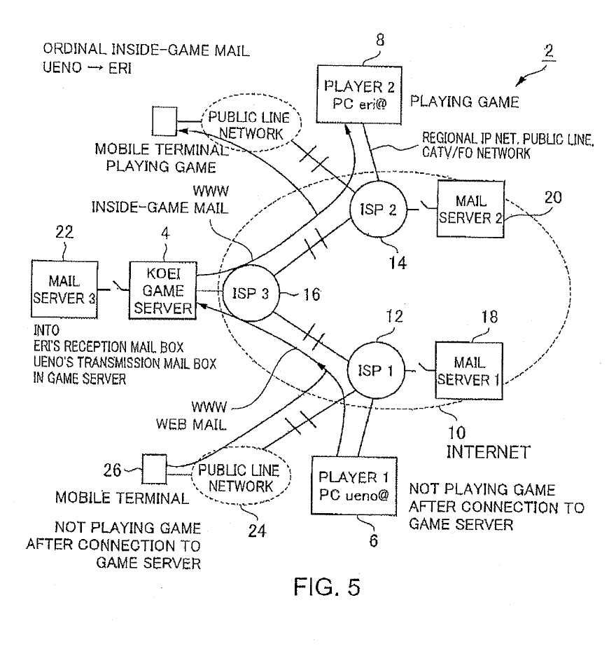

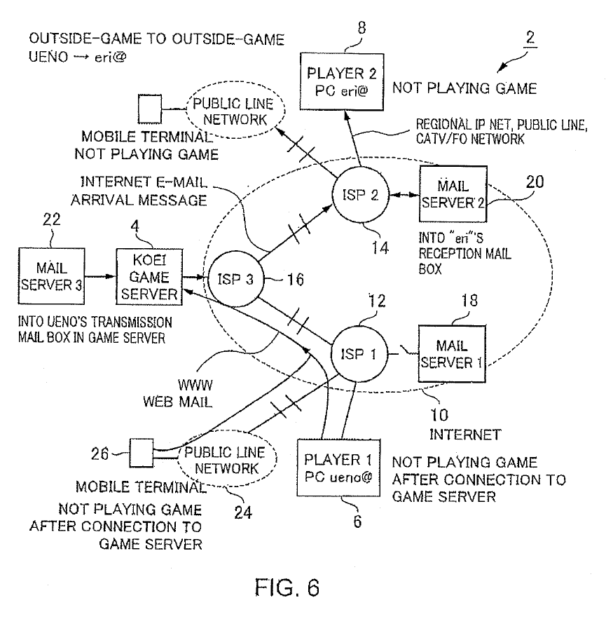

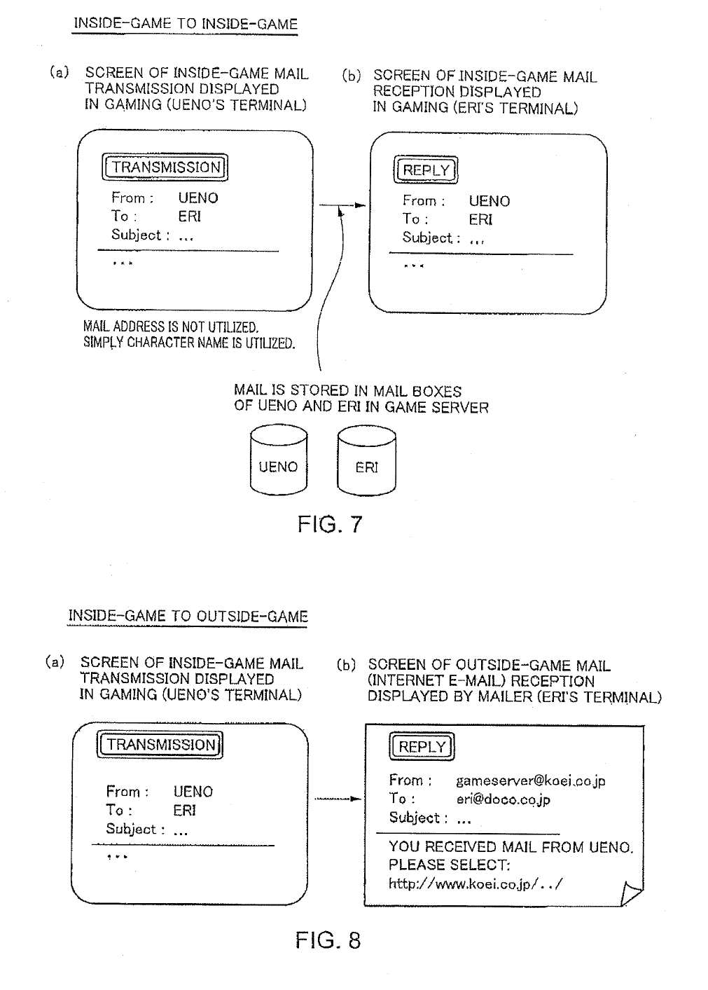

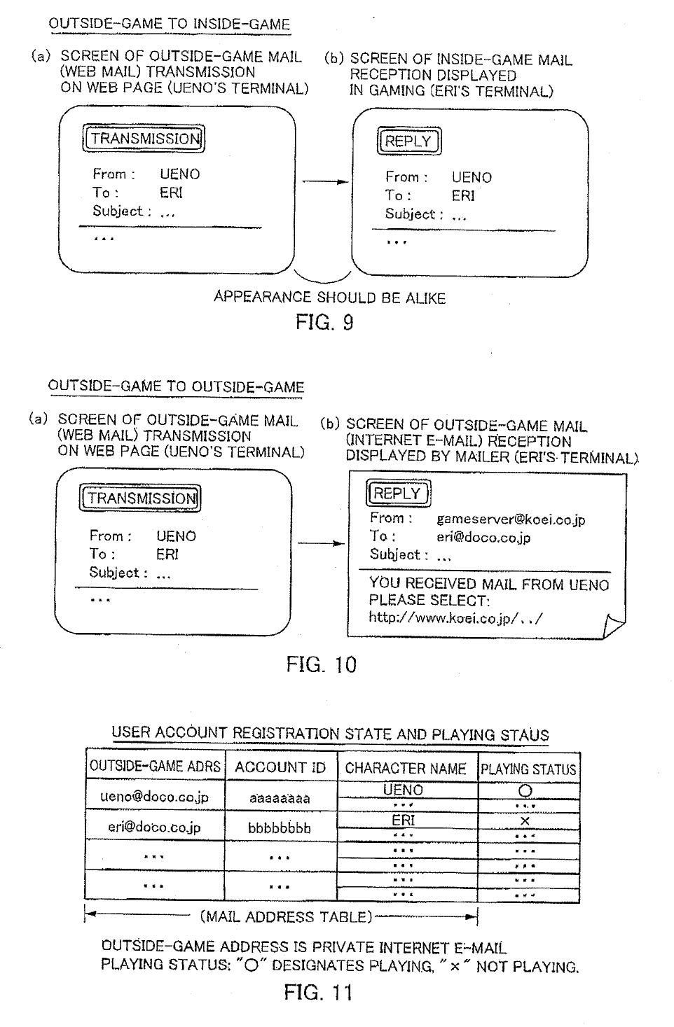

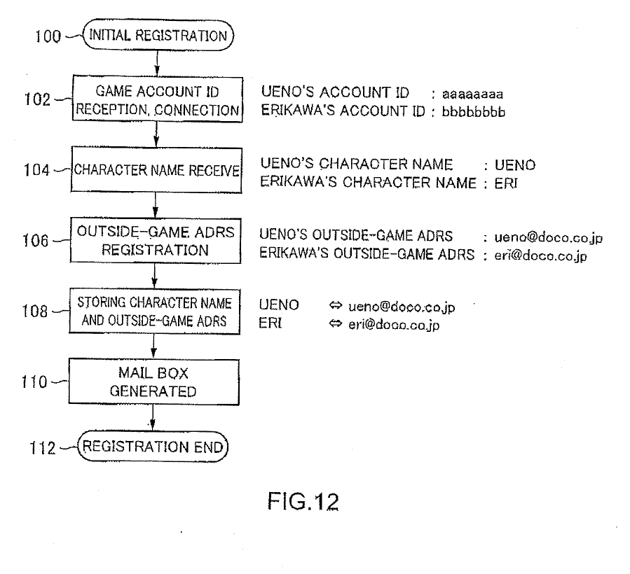

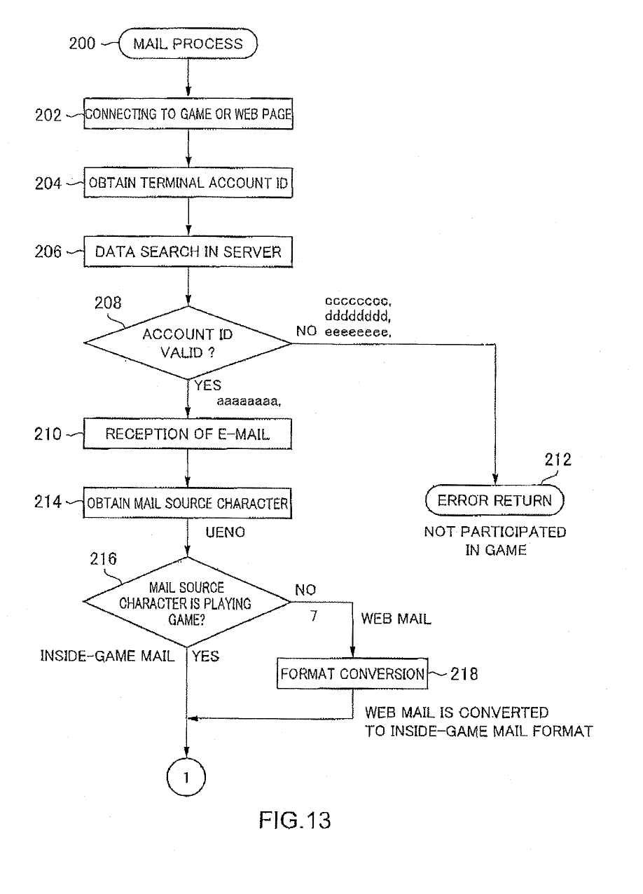

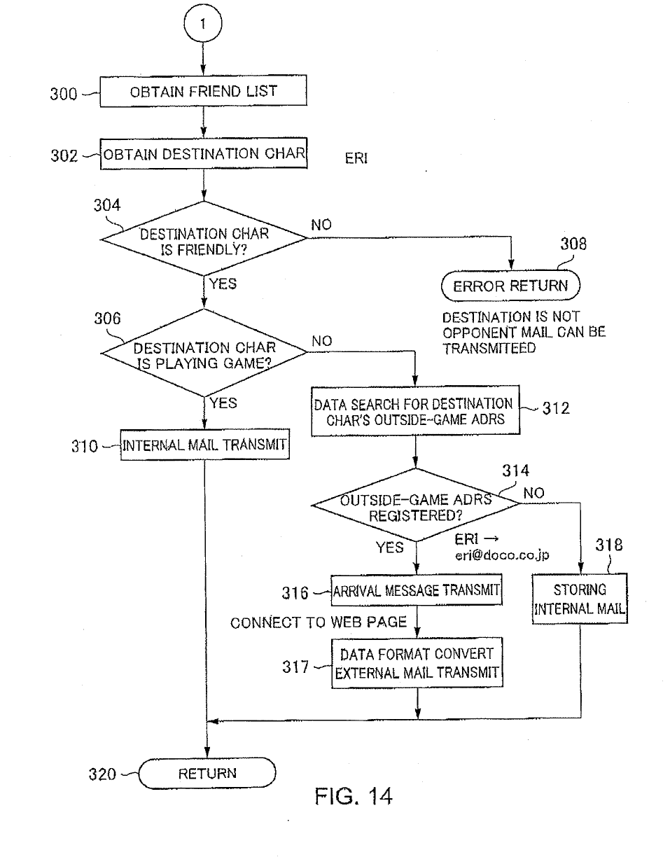

### EXPLANATION OF REFERENCE NUMERALS

2 e-mail community system; 4 dedicated server (also referred to as “game server” or simply “server”); 6 first terminal equipment; 8 second terminal equipment; 10 Internet; 12 first internet service provider (ISP1); 14 second Internet service provider (ISP2); 16 third Internet service provider (ISP3); 18 first mail server (mail server 1); 20 second mail server (mail server 2); 22 third mail server (mail server 3); 24 public line network; and 26 mobile terminal.

1. An e-mail community system for a network game comprising a multi-participant network game which proceeds by intensively administrating a virtual space shared by a dedicated server and a plurality of items of terminal equipment usig transmission/reception between a dedicated server and terminal equipment,
in which the network game proceeds by players on terminal equipment operating characters of each user displayed in the virtual space, a character of the player on one terminal equipment being able to communicate with characters operated by other users on their terminal equipment, comprising means for performing
a step whereby when the terminal equipment of a mail source is connected to the game, an inside-the-game mail from the mail source using a character name is received and a character name of a destination is acquired, so that thereafter if the destination is currently playing the game, then an internal e-mail by the inside-the-game mail is transmitted as required by the destination, whereas if the destination is not currently playing the game, then the inside-the-game mail is converted into a Web mail format to perform an external e-mail transmission by a Web mail addressed to the character name.

2. The e-mail community system for a network game according to claim 1 comprising means for performing
a step of associating a character name with an Internet e-mail address of a player on the terminal equipment and recording the association in a dedicated server; and
a step whereby when the terminal equipment of a mail source is connected to the game, an inside-the-game mail from the mail source using a character name is received and a character name of a destination is acquired, so that thereafter if the destination is currently playing the game, then an internal e-mail by the inside-the-game mail is transmitted as required by the destination, whereas if the destination is not currently playing the game and the Internet e-mail address has been registered, then an Internet e-mail is used to transmit an arrival message addressed to the Internet e-mail address corresponding to the character name and so that thereafter the inside-the-game mail is converted to a Web mail format to perform an external e-mail transmission by a Web mail addressed to the game character name as required by the destination.

3. The e-mail community system for a network game according to claim 1 comprising means for performing
a step whereby when the terminal equipment of a mail source is connected to a Web page, a Web mail from the mail source using a character name is received and the Web mail is converted into an inside-the-game mail format and a character name of a destination is acquired, so that thereafter if the destination is currently playing the game, then an internal e-mail by the inside-the-game mail is transmitted as required by its destination, whereas if the destination is not currently playing the game, then the inside-the-game mail is converted to a Web mail format to perform an external e-mail transmission by a Web mail addressed to the game character name.

4. The e-mail community system for a network game according to claim 1 further comprising means for performing
a step of associating a character name with an Internet e-mail address of a player on the terminal equipment and recording the association in a dedicated server; and
a step whereby when the terminal equipment of a mail source is connected to a Web page, a Web mail message using a character name is received and Web mail is converted into an inside-the-game mail format and a character name of a destination is acquired, so that thereafter if the destination is currently playing the game, then an internal e-mail by the inside-the-game mail is transmitted as required by the destination, whereas if the destination is not currently playing the game and the Internet e-mail address has been registered, then an Internet e-mail is used to transmit an arrival message addressed to the Internet e-mail address corresponding to the character name and so that thereafter the inside-the-game mail is converted to a Web mail format to perform an external e-mail transmission by a Web mail addressed to the game character name as required by the destination.

5. A program for an e-mail community system for a network
game comprising a multi-participant network game which proceeds by intensively administrating a virtual space shared by a dedicated server and a plurality of items of terminal equipment using transmission/reception between a dedicated server and terminal equipment,
in which the network game proceeds by players on terminal equipment operating characters of each user displayed in the virtual space, a character of the player on one terminal equipment being able to communicate with characters operated by other users on their terminal equipment, comprising means for performing, the program functioning as
means whereby when the terminal equipment of a mail source is connected to the game, an inside-the-game mail from the mail source using a character name is received and a character name of a destination is acquired, so that thereafter if the destination is currently playing the game, then an internal e-mail by the inside-the-game mail is transmitted as required by the destination, whereas if the destination is not currently playing the game, then inside-the-game mail is converted into a Web mail to perform an external e-mail transmission by a Web mail addressed to the game character name.

6. The program for an e-mail community system for a network game according to claim 5, whereby the program further functions as:
means for associating a character name with an Internet e-mail address of a player on the terminal equipment and recording the association in a dedicated server; and
means whereby when the terminal equipment of a mail source is connected to the game, an inside-the-game mail from the mail source using a character name is received and a character name of a destination is acquired, so that thereafter if the destination is currently playing the game, then an internal e-mail by the inside-the-game mail is transmitted as required by the destination, whereas if the destination is not currently playing the game and the Internet e-mail address has been registered, then an Internet e-mail is used to transmit an arrival message addressed to the Internet e-mail address corresponding to the character name and so that thereafter the inside-the-game mail is converted to a Web mail format to perform an external e-mail transmission by a Web mail addressed to the game character name as required by the destination.

7. The program for an e-mail community system for a network game according to claim 5, whereby the program further functions as:
means whereby when the terminal equipment of a mail source is connected to a Web page, a Web mail message using a character name is received and Web mail is converted into a inside-the-game mail format and a character name of a destination is acquired, so that thereafter if the destination is currently playing the game, then an internal e-mail by the inside-the-game mail is transmitted as required by the destination, whereas if the destination is not currently playing the game, then the inside-the-game mail is converted to a Web mail format to perform an external e-mail transmission by a Web mail addressed to the game character name.

8. The program for an e-mail community system for a network game according to claim 5, whereby the program further functions as:
means for associating a character name with an Internet e-mail address of a player on the terminal equipment and recording the association in a dedicated server; and
means whereby when the terminal equipment of a mail source is connected to a Web page, a Web mail from the mail source using a character name is received and the Web mail is converted into an inside-the-game mail format and a character name of a destination is acquired, so that thereafter if the destination is currently playing the game, then an internal e-mail by the inside-the-game mail is transmitted as required by the destination, whereas if the destination is not currently playing the game and the Internet e-mail address has been registered, then an Internet e-mail is used to transmit an arrival message addressed to the Internet e-mail address corresponding to the character name and so that thereafter the inside-the-game mail is converted to a Web mail format to perform an external e-mail transmission by a Web mail addressed to the game character name as required by the destination.

9. A computer-readable storage medium on which the program of claim 5 is recorded.

10. A computer-readable storage medium on which the program according to claim 6 is recorded.

11. A computer-readable storage medium on which the program according to claim 7 is recorded.

12. A computer-readable storage medium on which the program according to claim 8 is recorded.
